(19) United States
(12) Patent Application Publication
(10) Pub. No.: US 2002/0130569 A1
(43) Pub. Date: Sep. 19, 2002

(54) Liquid phase flywheel for energy storage

(76) Inventors: Stan L. Reynolds, Oceanside, CA (US); Torsten Kruger, Leucadia, CA (US)

Correspondence Address: Harry V. McGahey, Esq., McGahey & McGahey, APC, 1532 Sixth Ave., San Diego, CA, 92101, US

(21) Appl. No.: 09/805,493

(22) Filed: Mar. 13, 2001

Related U.S. Application Data
(60) Provisional application No. 60/241,386, filed on Oct. 17, 2000.

(51) Int. Cl. H02K 7/02

(52) U.S. Cl. 310/74

(57) ABSTRACT

A fluid filled flywheel comprised of a hollow, internally veined, semi spherical shape containing a fluid is used to impart inertia to a system as a function of fluid density, volume and speed of rotation for the purposes of energy storage.

### CROSS REFERENCE

This application is entitled to the benefit of U.S. Provisional Patent Application Ser. No. 60/241,386 filed Oct. 17, 2000.

### BACKGROUND OF THE INVENTION

Conventional methods of physical and electrical power generation have an inherent weakness in that once the power is generated it must be used. For example, a fossil fuel fired power plant must generate electrical energy to accommodate widely varying peak and trough demands. Under the current technological paradigm, this energy must be generated on demand, thus resulting in operational fluctuations, which are costly and difficult to manage. Being cognizant of this problem electrical utilities have long sought devices capable of power storage such as batteries, capacitor banks, etc. Conventional flywheels have been found to be useful in this regard, however their large mass and the safety hazard in the event of rupture has discouraged their use.

The same problems are also inherent in alternative energy generation devices. Windmill and solar energy systems are essentially direct power translation devices: when the wind stops, the power goes off; when the sun sets, the solar panels don't work. Manufacturers of these devices have long recognized that alternative power generation would be able to offer serious competition to fossil fuel power generation, if a commercially feasible power storage mechanism could be developed.

Supplementing the need for a commercially viable energy storage device, is the ever increasing demand for new, alternative, commercial energy sources. Concerning such potential new sources, strong emphasis is placed on safety in operation and environmental soundness. Furthermore, considerable public interest has been expressed regarding the need for individual family size alternative power generation systems that are both safe and environmentally sound.

Accordingly, it is a primary objective of the present invention to accommodate all of the above cited needs, although any energy source could be used to supply the Liquid Phase Flywheel (hereafter “LPF”).

The use of flywheels for industrial applications dates back well over a hundred years. From the outset, however, use of these devices was hampered by the following limitations:

### LIMITATIONS OF PRIOR ART

1. To maximize the moment of inertia about the rotational axis, an optimization compromise must be reached between weight and speed of rotation. Historically, this compromise has resulted in flywheels which are quite massive and which rotate at high speeds.

2. The result from (1) above is that moving the flywheel from stasis to full rotational speed requires large activation energies, because the entire mass, rigidly affixed to the shaft, must be moved simultaneously as a unit.

3. When a flywheel is at fill rotational speed, the moment of inertia at the rim forces the inverse of (2) above when a workload is placed on the axis shaft thus setting up lateral shear force instabilities along the plane of the wheel.

4. Due to the mass of the wheel and its speed of rotation the instabilities from (3) above have historically led to disastrous results involving either flywheel rupture or displacement.

5. Conventional flywheels do not have the design option of being rotated in any plane due to the limitations imposed by (1), (2), (3) and (4) above.

Historical attempts to address some or all of the above limitations are reflected in the following prior art:

U.S. Pat. No. 1,254,694 by Ralph Humphries: Flywheel, Jan. 29, 1918

U.S. Pat. No. 2,404,515 by Frank W. Meyer: Hydraulic Flywheel, Jul. 23, 1946

U.S. Pat. No. 3,970,409 by George Luchuk: Wind power and flywheel apparatus, Jul. 20, 1976

U.S. Pat. No. 4,060,009 by Howard John Wyman: Balancing Rotors, Nov. 29, 1977

U.S. Pat. No. 4,335,627 by Thomas J. Maxwell: Hydraulic Flywheel, Jun. 22, 1982

The Humphries flywheel (U.S. Pat. No. 1,254,694) utilized a flattened dish shaped structure in which a fluid or pseudofluid in the form of balls was concentrated at the axis such that upon rotation the balls would be thrown axially to the rim. This action would provide the necessary moment of inertia at fill rotation, however the Humphries flywheel does not allow for infinitely variable moments of inertia but rather produces a step function where the balls are either at the axis or at the rim. The Humpbries device addressed the limitations set forth under (1) and (2) above but did not address the limitations set forth under (3) (4) and (5).

The Meyer flywheel (U.S. Pat. No. 2,404,515) utilized a truncated, hollow, cylindrical structure, which was completely filled with fluid introduced via an internal, valved opening communicating with the axial shaft. The hollow flywheel was fitted with a series of arcurate vanes pivotally supported within the annular chamber to prevent or retard the movement or flow of liquid. As such, the Meyer flywheel had as its primary foci the saving of metal and ease of repair. To some extent the Meyer flywheel resolves limitation (4) above because the design incorporated fluid release mechanisms under upset conditions. The design does not resolve any of the other numbered limitations, however, because it was not intended to do so.

The Luchuk flywheel (U.S. Pat. No. 3,970,409) overcomes limitations 2 above, but does not overcome the limitations nos. 3, 4 and 5.

The Wyman device (U.S. Pat. No. 4,060,009) is not properly a flywheel, although some of the principles are the same. The invention pertains to a mechanism, which allows permanent balancing particularly although not exclusively applicable to motor vehicle propeller (rotor) shafts. This device has a prior art relationship to the subject invention because it utilizes a pseudofluid in the form of balls to seek stable equilibrium in a spinning rotor. Having achieved said equilibrium an adhesive is thermally activated and used to permanently set the balls at this equilibrium point. In the event that the Wyman procedure was adapted to equilibrating instabilities in a conventional flywheel, it would address limitation (4) above but would not overcome any of the other numbered limitations.

The Maxwell hydraulic flywheel (U.S. Pat. No. 4,335,627) represents the closest prior art relationship to the subject invention in that it relates to a variable moment of inertia system achieved by hydraulic means. The Maxwell hydraulic flywheel consists of a hollow dished structure of separable sections. At least one of these separable sections is affixed rigidly to the drive shaft. The second separable section is slidable along the drive shaft such that when it is brought into contact with the rigidly affixed section it forms a sealed structure capable of holding a fluid. The entire described unit is enclosed within a reservoir holding the fluid, which is pumped into the flywheel through openings in the drive shaft. Introducing the fluid as required, or ejecting it via selective separation of the sections achieves the variable moment of inertia. This is accomplished by feedback controls and pumping mechanisms.

The Maxwell hydraulic flywheel overcomes all of the above numbered limitations, however the design differs significantly from the subject invention (which also overcomes all of the numbered limitations) in the following ways:

1. The subject invention moves from stasis to full rotation with a fixed quantity of fluid. Infinitely variable momentum in the subject invention is a function of the geometry of the flywheel and its speed of rotation. The subject invention is not dependent on pumping devices, liquid ejection, or fluid flow controls and feedback loops to vary the moment of inertia.

2. The subject invention need not be enclosed in a reservoir because its fluid volume remains fixed. This permits use of the external surface for such applications as are described herein for the subject invention.

3. The subject invention is self-stabilizing

4. The subject invention does not require separable sections for its function and therefore, does not need the fine controls necessary for selective ejection of hydraulic fluid.

5. Due to the above described conditions the subject invention is not size limited.

### SUMMARY OF THE INVENTION

The present invention utilizes a hollow, internally veined, semi spherical device containing a fluid, which imparts inertia to the system as a function of fluid density, volume and speed of rotation.

To avoid confusion the term “semi sphere” is used throughout, however, the actual geometry may range from elliptical, to conical, to parabolic, to semispherical, to hemispheric, to round, depending on speed of rotation, type of fluid used, and structural demands of the application.

The effect is that of a liquid phase flywheel (“LPF”), with energy storage and generation characteristics typical of conventional flywheels. The invention herein described has two functions: (1) an energy storage device, and (2) an alternative energy generation device.

### DESCRIPTION OF THE DRAWINGS

FIG. 1 is a three-dimensional model of the device embodying various features of the invention. A semi spherical structure, indicated generally at 1, acts as the flywheel shell and fluid container. This structure is fabricated from composite fiber, ceramics composites, metal composites, multi-matrix composites, or similar material and is rigid but has sufficient flexibility to deform to exact equilibrium in response to centrifugal forces brought on by the liquid rising along the walls. Thus, in the event of catastrophic failure, the vessel wall will rupture, the internal fluid will be harmlessly released and the safety concerns common to conventional flywheels are thereby addressed.

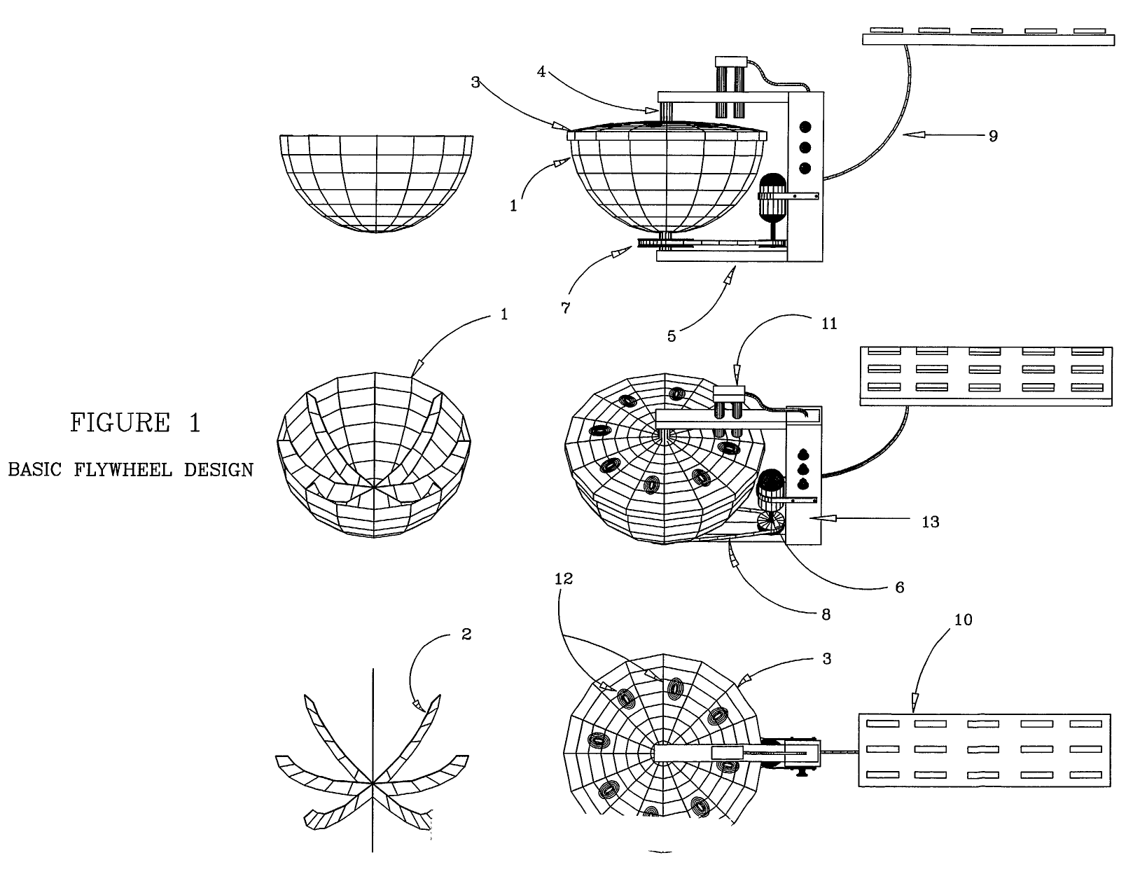

A perforated radial vein cluster (hereafter “RVC”), indicated generally at 2, is bonded to the inner surface of the semi sphere. The purpose of the RVC is to create inertial momenta through interaction with the liquid torus when power drain is initiated. Absent the RVC, shear forces between the liquid torus and the semi sphere wall are too small to harness the potential energy contained in the rotating liquid torus. The RVC perforations allow continuous communication among and between vein segments such that destabilization resulting from unequal weight distribution of the internal fluid does not occur during rotation. The perforations are distributed such that equilibration is permitted while still allowing sufficient vein surface to permit translation of potential energy in the spinning torus to kinetic energy at the axis shaft indicated generally at 4.

The axis shaft indicated generally at 4, is bonded to the semi spheric shell such that shaft and shell are a seamless unit so that as the shell spins, the shaft turns. The axis shaft is seated in a bearing system mounted in the frame located generally at 13. Also affixed to the shaft is a pulley wheel located generally at 7, which in turn communicates via pulley belt, located generally at 8, to an electrical motor, located generally at 6. The electrical motor is connected by power cable located generally at 9, which, in turn, is connected to a power source (here, as an example, a solar panel, located generally at 10) from which a small fraction of its generated power is diverted. Any sort of drive system means such as gears, or a direct drive system can be also be affixed to the shaft upon which the shell spins.

The LPF generates electricity via an interface between discrete copper coils, located generally at 12 and the magnetic field generated by the magnet located generally at 11, in the manner of a conventional electrical generator.

### DETAILED DESCRIPTION OF THE PREFERRED EMBODIMENTS

In a method of storing energy for subsequent use in power generation, a semi spherical vessel is fitted with perforated veins that are perpendicular to the vessel surface and radiate outward from their point of intersection at the semi sphere vertex to the semi sphere rim The purpose of the vein perforations is to allow equilibration between vein segments so as to preclude destabilization during rotation. Any fluid (such as for example, water) is placed in the semi sphere such that the veins at their point of intersection are immersed. Optionally, a porous matrix (i.e. sponge, gel, foam, labyrinth etc.) can be added between the internal vanes for added stability and shear resistance.

The semi sphere is then sealed with a cover on which, is affixed discrete coils of copper wire. The described apparatus is in turn affixed to a shaft aligned along its rotational axis.

The shaft is mounted on a bearing system contained in a support frame to which is affixed a magnet such that the magnetic field is adjusted to close proximity of the aforementioned copper coils attached to the semi sphere cover. Also mounted to the support frame is an electrical motor for use in spinning up the flywheel.

A bleed stream from a power source, such as from an electrical solar panel, operates the motor attached to the frame, which in turn begins to spin up the flywheel. From its stationary position the flywheel has minimal inertia, because the fluid is at rest at the vertex of the semi sphere. As rotation of the semi sphere increases, however, the fluid begins to rise along the walls due to centrifuigal force. At sufficiently high rotation rates, the fluid becomes a torus situated along the upper rim of the semi sphere, at which point maximum momentum and inertia exist and the energy from the energy source (i.e, a solar panel or windmill for example) is now stored as potential energy. This potential energy is converted to electrical energy for use by the consumer via the generator consisting of the rotting copper coils in proximity to the magnetic field as described above.

Only a small fraction of diverted power is required because the interface between semi sphere and liquid phase acts as an infinitely gradual slip clutch between the points of stasis and full rotational speed. This is a principal characteristic of the present invention, which differentiates it from conventional flywheels, which require overcoming 100% of inertial mass from stasis onward. Accordingly, the tradeoff in the current invention is power versus time. Very little power diversion is required to spin up the flywheel, however, the tradeoff is the extended time interval required to achieve maximum rotation Thus, the principal energy output of the power source (in this case a solar panel) can be used for its intended consumer purpose, while the fractional power stream diverted to the LPF serves to store energy for later use during downtime.

Alternatively, the LPF can function as a primary power source. By way of example, an LPF unit sized to accommodate a single family dwelling, would be operated through diversion of all of the power from a solar panel, windmill, etc. such that all electrical power is derived from the LPF. Under this scenario, the LPF would always be maintained at close to full rotation and would act metaphorically as an electrical surge tank, while still providing power reserves during trough periods. The Generation of electricity would be via the interface between the discrete copper coils, located generally at 12, and the magnetic field generated by the magnet located generally at 11, in the manner of a conventional electrical generator.

Alternatively, the LPF may be used for power generation other than electrical as for example in automotive applications. For example, the LPF axis shaft located generally at 4, could be connected mechanically to an automobile drive shaft, such that LPF rotational speed is translated to automobile motion. The advantage of this scenario is an essentially free power source. A small solar panel mounted on the roof of the automobile would gradually spin up the flywheel while the automobile is sitting in the sun. Additional power savings in this design would be realized by retranslating braking power back to flywheel rotation. Flywheels have long been recognized as excellent devices for automotive transportation but have not been used due to their massive weight and extreme hazard in the event of catastrophic failure. Both of these concerns are eliminated by the design parameters of the current invention.

What is claimed is:

1. An apparatus for storing energy for subsequent use in electrical or physical power generation, comprising a semi spheric liquid phase flywheel connected by a mechanical means to a shaft aligned along the rotational axis of the flywheel.

2. The liquid phase flywheel according to claim 1, in which a semi spheric structure acts as the flywheel shell and fluid container.

3. The liquid phase flywheel according to claim 2, in which a semi spheric structure made of a composite material acts as the flywheel shell and fluid container.

4. The liquid phase flywheel according to claim 2 and 3, wherein a perforated radial vein cluster is bonded to the inner surface of the semispheric structure.

5. The liquid phase flywheel according to claim 4, wherein a porous matrix is placed between the internal vanes.

6. The liquid phase flywheel according to claims 1, 2, 3 or 4 wherein small round or viscous particles are used in place of a fluid.

7. The liquid phase flywheel according to claim 1 wherein the liquid phase flywheel is fitted with electrically conducting elements which, in rotating through a magnetic field, result in the generation of electrical power.

8. The liquid phase flywheel according to claim 2 wherein the liquid phase flywheel is fitted with electrically conducting elements which, in rotating through a magnetic field, result in the generation of electrical power.

9. The liquid phase flywheel according to claim 3, wherein the liquid phase flywheel is fitted with electrically conducting elements which, in rotating through a magnetic field, result in the generation of electrical power.

10. The liquid phase flywheel according to claim 4, wherein the liquid phase flywheel is fitted with electrically conducting elements which, in rotating through a magnetic field, result in the generation of electrical power.

11. The liquid phase flywheel according to claim 5 wherein the liquid phase flywheel is fitted with electrically conducting elements which, in rotating through a magnetic field, result in the generation of electrical power.

12. The liquid phase flywheel according to claim 6 wherein the liquid phase flywheel is fitted with electrically conducting elements which, in rotating through a magnetic field, result in the generation of electrical power.

13. A method for storing energy for subsequent use in electrical or physical power generation comprising a liquid phase flywheel connected by a mechanical means to a shaft aligned along the rotational axis of the flywheel.

14. A method for storing energy for a subsequent use in electrical or physical power generation according to claim 13 in which a semi spheric structure acts as the flywheel shell and fluid container.

15. A method for storing energy for a subsequent use in electrical or physical power generation according to claim 14 in which a semi spheric structure made of a composite material acts as the flywheel shell and fluid container.

16. A method for storing energy for a subsequent use in electrical or physical power generation according to claim 14 or 15 in which a perforated radial vein cluster is bonded to the inner surface of the semispheric structure.

17. A method for storing energy for a subsequent use in electrical or physical power generation according to claim 16 wherein a porous matrix is placed between the internal vanes.

18. A method for storing energy for a subsequent use in electrical or physical power generation according to claim 13, 14, 15, 16, or 17 wherein small round or viscous particles are used in place of a fluid.

19. A method for storing energy for a subsequent use in electrical or physical power generation according to claims 13, 14, 15, 16, 17, or 18 wherein the rotating device is fitted with electrically conducting elements which, in rotating through a magnetic field, result in the generation of electrical power.

20. A method for storing energy for a subsequent use in electrical or physical power generation according to claims 1, 2, 3, 4, 5, or 6 wherein the rotating device is attached by mechanical means to a means of generating electrical power.

21. A method according to claims 1, 2, 3, 4, 5, of 6 in which rotational energy is translated to physical work through direct mechanical coupling means to the rotating shaft.

22. A method according to claims 1, 2, 3, 4, 5 or 6 in which rotational energy is translated to physical work through indirect magnetic coupling means to the rotating shaft.

23. A method for storing energy for a subsequent use in electrical or physical power generation according to claims 1, 2, 3, 4, 5, or 6 in which rotational energy is translated to electrical energy through indirect magnetic coupling means to a means of generating electrical power.
